(19) United States
(12) Patent Application Publication
(10) Pub. No.: US 2012/0224620 A1
(43) Pub. Date: Sep. 6, 2012

(54) APPARATUS AND METHOD FOR RECEIVING DATA IN A COMMUNICATION SYSTEM

(75) Inventors: Sung-Ik Park, Daejeon (KR); Heung-Mook Kim, Daejeon (KR)

(73) Assignee: Electronics and Telecommunications Research Institute, Daejeon (KR)

(21) Appl. No.: 13/509,343

(22) PCT Filed: Aug. 10, 2010
(86) PCT No.: PCT/KR2010/005233

§ 371 Date: May 11, 2012

(30) Foreign Application Priority Data
Nov. 13, 2009 (KR) 10-2009-0109603
May 19, 2010 (KR) 10-2010-0046924

(51) Int. Cl. H04L 1/00; H04L 27/01; H04B 1/16

(52) U.S. Cl. 375/229; 375/340

(57) ABSTRACT

The present invention relates to an apparatus and a method for receiving data using a low-density parity check (LDPC) decoding scheme in a digital broadcasting system. The method comprises calculating a parity check matrix of a trellis coded modulation symbol from data that is received via an antenna; transforming the calculated parity check matrix into a low-density parity check matrix; decoding the data having been received via the antenna, based on the transformed low-density parity check matrix; and recovering the data having been received via the antenna.

### TECHNICAL FIELD

Exemplary embodiments of the present invention relate to a communication system; and, more particularly, to an apparatus and method for receiving data using Low-Density Parity Check (LDPC) decoding scheme in a digital broadcasting system.

### BACKGROUND ART

Many studies have been actively made for providing various services to users with different quality of service (QoS) at a high speed transmit rate in a next generation communication system. In a digital broadcasting system as an example of the next generation communication system, many methods have been introduced to stably and quickly provide digital broadcasting including video and audio data to a user using a limited resource. In other words, the digital broadcasting system has been introducing various transmission methods for improving a data transmit rate of digital broadcasting data including various types of video and audio date. Particularly, various types of encoding and decoding schemes have been introduced to stably transmit a mess amount of broadcasting data.

As an example of a method for stably transmitting a mess amount of broadcasting data at a high speed data transmit rate in a digital broadcasting system, a convolutional code based encoding and decoding method has been introduced. In the convolutional code based encoding and decoding method, a convolutional code is used to encode and decode broadcasting data. As an example of a convolutional code based encoding and decoding method, a Trellis Coded Modulation (TCM) encoding and decoding method has been introduced.

When a digital broadcasting system uses the TCM encoding and decoding method to provide a digital broadcasting to a user, a receiver of the digital broadcasting system decodes a TCM code based on Trellis in order to firstly eliminate noises generated from a channel of transmitting broadcasting data. The receiver may effectively decode the TCM code through a Viterbi algorithm having a low complexity. However, the decoding performance is significantly deteriorated if the Viterbi algorithm is used to decode the TCM code. Particularly, there is a comparatively large difference between the decoding performance of the TCM code and Shannon's channel capacity limit. Therefore, there is a limitation to stably and normally provide high quality digital broadcasting to a user.

That is, in the digital broadcasting system, a transmitter encodes broadcasting data to TCM codes and transmits the TCM codes to a receiver. A receiver provides the digital broadcasting to a user by decoding the received TCM codes of the broadcasting data using a Viterbi algorithm. However, when the receiver uses the Viterbi algorithm to decode the TCM codes of broadcasting data as described above, the decoding performance of the TCM code is not close to Shannon's channel capacity limit. As a result, decoding error increases. Such a decoding error causes a problem in providing high quality digital broadcasting to a user.

Therefore, a communication system, for example, a digital broadcasting system, requires a decoding method that decodes the TCM codes of broadcasting data with a decoding performance close to Shannon's channel capacity limit so as to minimize decoding error. Such a communication system also requires a data receiving method for stably providing high quality digital broadcasting to a user by decoding the TCM codes of broadcasting data using a required decoding method.

### DISCLOSURE

### Technical Problem

An embodiment of the present invention is directed to an apparatus and method for receiving data in a communication system.

Another embodiment of the present invention is directed to a data receiving apparatus and method for minimizing decoding errors by decoding broadcasting data encoded based on a Trellis Coded Modulation (TCM) encoding scheme with a decoding performance close to Shannon's channel capacity limit.

Another embodiment of the present invention is directed to a data receiving apparatus and method for decoding TCM encoded data using a Low-Density Parity Check (LDPC) decoding scheme in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an embodiment of the present invention, an apparatus for receiving data in a communication system includes a demodulator configured to demodulate data received through an antenna using a Vestigial SideBand (VSB) demodulation scheme, an equalizer configured to equalize the demodulated data, a first decoder configured to decode the equalized data using a Low-Density Parity Check (LDPC) decoding scheme, a deinterleaver configured to deinterleave the LDPC decoded data, a second decoder configured to decode the deinterlevaed data using a Reed-Solomon (RS) decoding scheme, and a derandomizer configured to restore the data received through the antenna by derandomizing the RS-decoded data.

In accordance with another embodiment of the present invention, an apparatus for receiving data in a communication system includes a decoder configured to decode data received through an antenna using an iterative decoding algorithm, wherein the decoder decodes a Trellis Coded Modulation (TCM) code of the data received through the antenna based on a Low-Density Parity Check (LDPC) decoding scheme using an iterative decoding algorithm.

In accordance with another embodiment of the present invention, a method for receiving data in a communication system includes calculating a Parity Check Matrix of a Trellis Coded Modulation (TCM) code from data received through an antenna, converting the calculated Parity Check Matrix to a Low-Density Parity Check (LDPC) matrix, and decoding the data received through the antenna based on the LDPC matrix and restoring the data received through the antenna.

### Advantageous Effects

A data receiving apparatus and method in accordance with an embodiment of the present invention receives broadcasting data encoded according to a Trellis Coded Modulation (TCM) scheme and decodes the received TCM coded broadcasting data using a Low-Density Parity Check (LDPC) decoding scheme. As a result, the decoding performance of the TCM coded broadcasting data becomes close to Shannon's channel capacity limit. Accordingly, the data receiving apparatus and method in accordance with an embodiment of the present invention can minimize decoding errors and stably provide high quality normal broadcasting data to a user. Further, the data receiving apparatus and method in accordance with an embodiment of the present invention can improve overall performance of a digital broadcasting system by improving the decoding performance and the receiving performance of the broadcasting data in a communication system.

### DESCRIPTION OF DRAWINGS

FIG. 1 is a diagram illustrating a data transmitting apparatus in a communication system in accordance with an embodiment of the present invention.

FIG. 2 is a diagram illustrating a data receiving apparatus in a communication system in accordance with an embodiment of the present invention.

FIG. 3 is a diagram illustrating a data receiving apparatus in a communication system in accordance with an embodiment of the present invention.

FIG. 4 is a flowchart showing operation of a data receiving apparatus in a communication system in accordance with an embodiment of the present invention.

### BEST MODE

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The present invention relates to an apparatus and method for receiving broadcasting data in a communication system such as a digital broadcasting system. In an exemplary embodiment of the present invention, a transmitter of a communication system encodes data based on a Trellis Coded Modulation (TCM) encoding scheme as an example of a convolutional code and transmits the TCM coded data. A receiver of the communication system receives the TCM coded data from the transmitter and decodes the TCM coded data using a Low-Density Parity Check (LDPC) as an example of a Forward Error Correction (FEC) scheme. A data transmitting apparatus in accordance with an embodiment of the present invention will be described to encode broadcasting data to a TCM code and transmit the TCM code in a digital broadcasting system. Further, a data receiving apparatus in accordance with an embodiment of the present invention will be described to receive the TCM coded broadcasting data and decode the TCM coded broadcasting data using a LDPC decoding scheme in the digital broadcasting system. However, a data receiving apparatus and method in accordance with an embodiment of the present invention is not limited thereto. The data receiving apparatus and method in accordance with an embodiment of the present invention can be applied to any communication systems including the digital communication system.

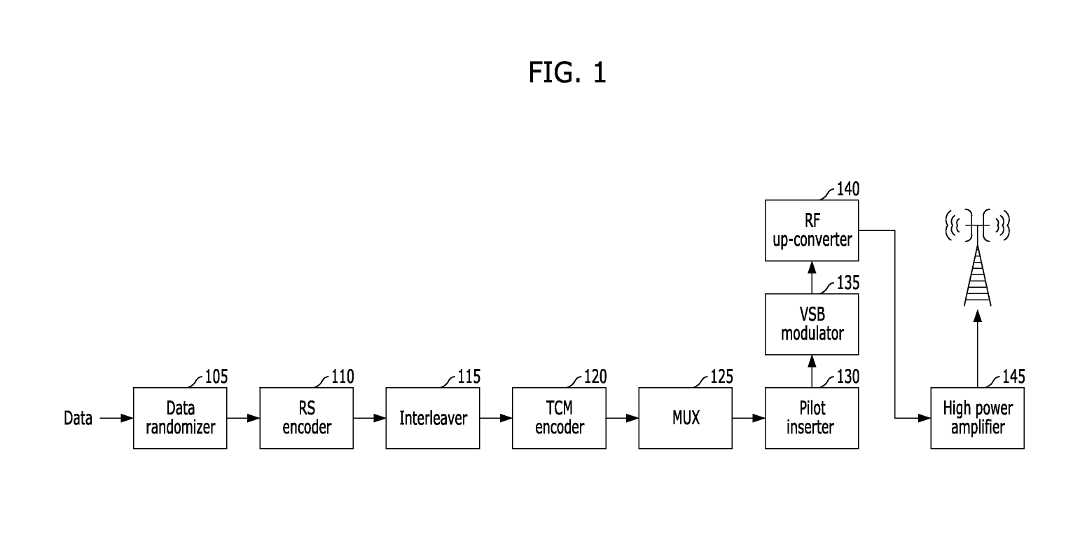

In a digital broadcasting system, a data receiving apparatus in accordance with an embodiment of the present invention receives TCM coded broadcasting data and decodes the TCM coded broadcasting data using a LDPC decoding scheme. Therefore, a decoding performance of TCM coded broadcasting data becomes close to Shannon's channel capacity limit and decoding errors are minimized. Accordingly, the data receiving apparatus in accordance with an embodiment of the present invention can stably provide normal high quality digital broadcasting to users. Hereinafter, the data receiving apparatus in accordance with an embodiment of the present invention will be described in detail with reference to FIG. 1.

FIG. 1 is a diagram illustrating a data transmitting apparatus in a communication system in accordance with an embodiment of the present invention. Particularly, FIG. 1 schematically illustrates a transmitter of an Advanced Television System Committee (ATSC) terrestrial digital TV system in a digital broadcasting system.

Referring to FIG. 1, the data transmitting apparatus includes a data randomizer 105, a Reed-Solomon (RS) encoder 110, an interleaver 115, a TCM encoder 120, a MUX 125, a pilot inserter 130, a VSB modulator 135, a RF up-converter 140, and a high power amplifier 145. The data randomizer 105 randomizes input broadcasting data. The RS encoder 110 receives the randomized data from the data randomizer 105 and encodes the randomized data to a RS code. The interleaver 115 receives the RS coded data from the RS encoder 110 and interleaves the RS coded data. The TCM encoder 120 receives the interleaved data from the interleaver 115 and encodes the interleaved data to a TCM code. The MUX 125 receives the TCM coded data from the TCM encoder 120 and multiplexes the TCM encoded data. The pilot inserter 130 inserts a pilot into the multiplexed data from the MUX 125. The VSB modulator 135 receives the pilot inserted data from the pilot inserter 130 and modulates the pilot inserted data using a Vestigial SideBand (VSB) modulation scheme. The RF up-converter 140 receives the modulated data from the VSB modulator 135 and up-converts the modulated data from a base band to a Radio Frequency (RF) band. The high power amplifier 145 amplifies the power of the up-converted data from the RF up converter 140 and transmits the amplified data through an antenna.

The data randomizer 105 receives a Moving Picture Experts Group (MPEG)-2 Transport Stream (TS) of broadcasting data and distributes spectrum of the received data through entire available frequency bands by randomizing the received data stream. Here, since the randomization of the data randomizer 105 distributes the data spectrum through entire bands, the data randomizer 105 prevents energy from concentrating to a specific frequency band when broadcasting data is transmitted.

The RS encoder 110 encodes the randomized data to a RS code having a superior capability of correcting burst error. Here, the RS encoder 110 encodes the randomized data to a RS code which is a linear code. Data error may be reduced through such a RS encoding. The interleaver 115 interleaves the RS coded data. The RS coded data is regularly rearranged through the interleaving.

The TCM encoder 120 encodes the interleaved data to a TCM code, which is an example of a convolution code. That is, the interleaved data is encoded to a TCM code which is a convolution code by the TCM encoder 120. The MUX 125 multiplexes the TCM coded data using a field synchronization signal and a segment synchronization signal. The multiplexed data is a baseband ATSC broadcasting data. That is, the TCM coded data is converted to the baseband ATSC broadcasting data through the multiplexing.

The pilot inserter 130 inserts a pilot to the multiplexed baseband ATSC broadcasting data. The pilot inserted data may be expressed as Equation 1 below.

t(n)=s(n)+P Eq. 1

In Equation 1, t(n) denotes the pilot inserted data, and s(n) represents the baseband ATSC broadcasting data. P denotes the pilot. For example, P may be a constant of 1.25 corresponding to ATSC.

The VSB modulator 135 modulates the pilot inserted baseband data using a VSB modulation scheme. The RF up-converter 135 up-converts the VSB modulated baseband data to a RF band data. That is, the VSB modulated baseband data is converted to a RF band data through the up-conversion. The high power amplifier 145 amplifies the power of the RF band data and transmits the amplified data to a data receiving apparatus of the digital broadcasting system through an antenna. Here, the VSB modulator 135 may modulate the pilot inserted baseband data and up-convert the baseband VSB modulated data to an Intermediate Frequency (IF) band VSB modulated data, and the up converter 135 may up-convert the IF VSB modulated data to a RF band data. Then, the high power amplifier 145 amplifies the power of the RF band data and transmits the amplified data through the antenna.

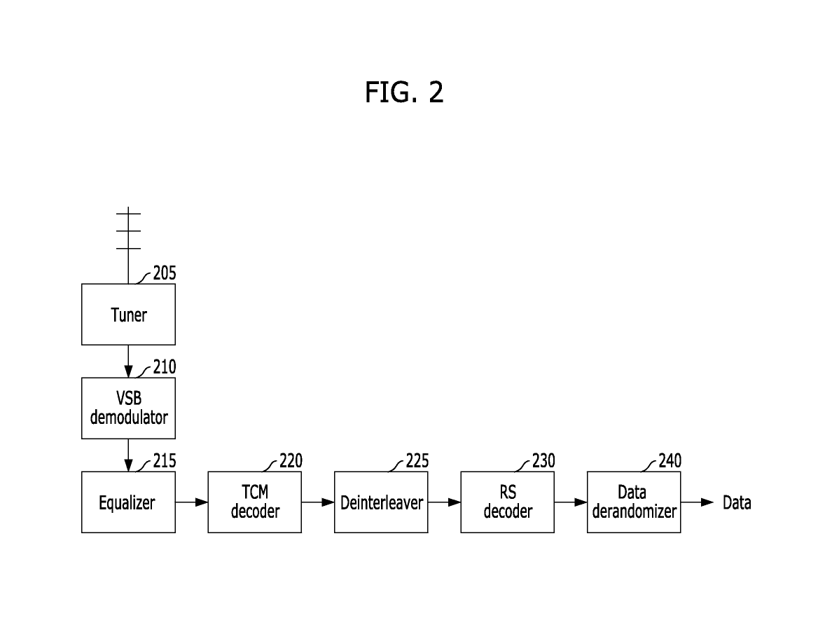

As described above, the data transmitting apparatus of the digital broadcasting system in accordance with an embodiment of the present invention encodes broadcasting data to a RS code and a TCM code and transmits the RS code and the TCM code to a data receiving apparatus. Hereinafter, a data receiving apparatus for receiving broadcasting data coded to RS codes and TCM codes in accordance with an embodiment of the present invention will be described in detail with reference to FIG. 2.

FIG. 2 is a diagram illustrating a data receiving apparatus in a communication system in accordance with an embodiment of the present invention. Particularly, FIG. 2 schematically illustrates a structure of a receiver of an ATSC terrestrial digital TV system in a digital broadcasting system.

Referring to FIG. 2, the data receiving apparatus includes a tuner 205, a VSB demodulator 210, an equalizer 215, a TCM decoder, 220, an deinterleaver 225, a RS decoder 230, and a data derandomizer 240. The tuner 205 receives coded broadcasting data through an antenna. The VSB demodulator 210 demodulates the received broadcasting data based on a VSB demodulation scheme corresponding to a VSB modulation scheme of the data transmitting apparatus. The equalizer 215 receives the VSB-demodulated data from the VSB demodulator 210 and equalizes the VSB-demodulated data. The TCM decoder 220 receives the equalized data from the equalizer 215 and decodes the equalized data based on a TCM scheme. The deinterleaver 225 receives the TCM decoded data from the TCM decoder 220 and deinterleaves the TCM decoded data. The RS decoder 230 receives the deinterleaved data from the deinterleaver 225 and decodes the deinterleaved data using a RS decoding scheme. The data derandomizer 240 receives the RS-decoded data from the RS decoder 230 and restores the broadcasting data by derandomizing the RS-decoded data.

The tuner 205 receives a RF band broadcasting data through an antenna and down-converts the RF band broadcasting data to a baseband broadcasting data. The VSB demodulator 210 demodulates the received baseband data based on a VSB demodulation scheme corresponding to a VSB modulation scheme of a data transmitting apparatus. Here, the RF band broadcasting data received through the antenna may be down-converted to IF band broadcasting data by the tuner 205, and the IF band broadcasting data may be demodulated and down-converted to the baseband VSB demodulated data by the VSB demodulator 210.

The equalizer 215 eliminates a multipath signal by equalizing the baseband VSB demodulated data. The multipath signal may be generated when broadcasting data is transmitted through a wireless channel. The TCM decoder 220 decodes the equalized data using a TCM decoding scheme corresponding to a TCM encoding scheme of the data transmitting apparatus. That is, the TCM decoder 220 decodes the received broadcasting data, which was encoded to a TCM code at the data transmitting apparatus, using a Viterbi algorithm. Here, the TCM decoder 220 removes noises from the TCM decoded data. The noise may be generated when the broadcasting data was transmitted through a wireless channel.

The deinterleaver 225 deinterleaves the TCM decoded data, and the RS decoder 230 decodes the deinterleaved data using a RS decoding scheme corresponding to a RS encoding scheme of the data transmitting apparatus. That is, the RS decoder 230 decodes the broadcasting data encoded to a RS code at the data transmitting apparatus. Here, the RS code is a linear code. The RS decoder 230 corrects a burst error from the RS decoded data. That is, the RS decoder 230 removes noises from the RS decoded data again. The noise may be generated when the broadcasting data is transmitted through a wireless channel. The data derandomizer 240 restores the broadcasting data by derandomizing the RS decoded data and outputs the MPEG-2 TS restored broadcasting data.

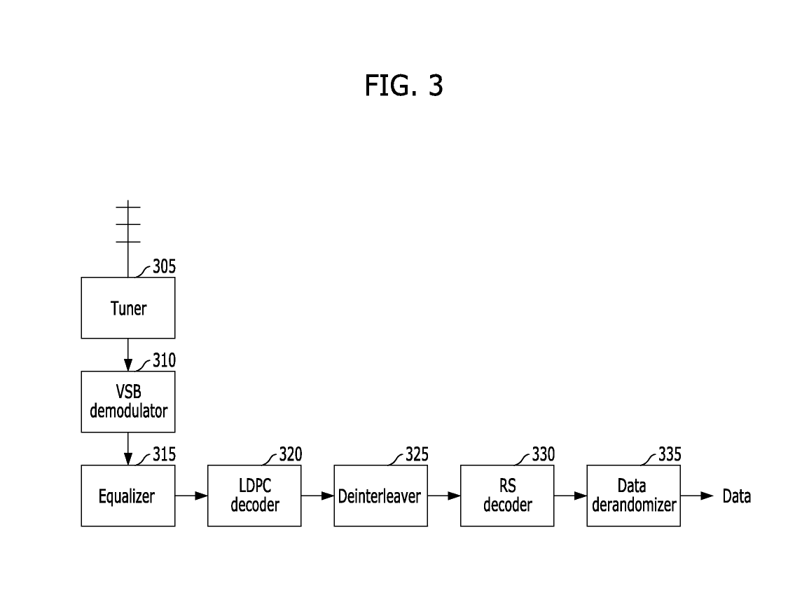

The data receiving apparatus in accordance with an embodiment of the present invention receives the broadcasting data encoded to the RS code and the TCM code and carries out the TCM decoding and the RS decoding on the received broadcasting data corresponding to the encoding schemes of the data transmitting apparatus. When the data receiving apparatus decodes the RS coded and TCM coded broadcasting data through a Viterbi algorithm, the decoding performance is significantly reduced. Particularly, there is a big difference between the decoding performance of the TCM code and Shannon's channel capacity limit. Accordingly, the decoding error of broadcasting data increases. In order to overcome such a problem, a data receiving apparatus in accordance with an embodiment of the present invention performs Low-Density Parity Check (LDPC) decoding in order to minimize the decoding error of the received broadcasting data by improving the decoding perform to be close to Shannon's channel capacity limit. Hereinafter, a data receiving apparatus for decoding RS coded and TCM coded broadcasting data in accordance with an embodiment of the present invention will be described in detail with reference to FIG. 3.

FIG. 3 is a diagram illustrating a data receiving apparatus in a communication system in accordance with an embodiment of the present invention. Particularly, FIG. 3 schematically illustrates a structure of a receiver of an ATSC terrestrial digital TV system in a digital broadcasting system.

Referring to FIG. 3, the data receiving apparatus in accordance with an embodiment of the present invention includes a tuner 305, a VSB demodulator 310, an equalizer 315, a LDPC decoder 320, a deinterleaver 325, a RS decoder 330, and a data de-randomizer 335. The tuner 305 receives coded broadcasting data through an antenna. The VSB demodulator 310 receives the coded broadcasting data from the tuner 305 and demodulates the coded broadcasting data based on a VSB demodulation scheme corresponding to a VSB modulation scheme of the data transmitting apparatus. The equalizer 315 receives the VSB-demodulated data from the VSB demodulator 310 and equalizes the VSB-demodulated data. The LDPC decoder 320 receives the equalized data from the equalizer 315 and decodes the equalized data based on a LDPC decoding scheme using an iterative decoding algorithm. The deinterleaver 325 deinterleaves the LDPC-decoded data from the LDPC decoder 320. The RS decoder 330 decodes the deinterleaved data from the deinterleaver 325 using a RS decoding scheme. The data derandomizer 335 restores the broadcasting data received through the antenna by derandomizing the RS-decoded data from the RS decoder 330.

The tuner 305 receives a RF band broadcasting data from an antenna and down-converts the RF band broadcasting data to a baseband data. The VSB demodulator 310 demodulates the baseband data based on a VSB demodulation scheme corresponding to a VSB modulation scheme of the data transmitting apparatus. Here, the RF band broadcasting data received through the antenna may be down-converted to an IF band broadcasting data by the tuner 305. The IF band broadcasting data may be demodulated based on a VSB demodulation scheme and down-converted to a baseband VSB demodulated data by the VSB demodulator 310.

The equalizer 315 eliminates a multipath signal by equalizing the baseband VSB modulated data. The multipath signal may be generated when the broadcasting data is transmitted through a wireless channel. The LDPC decoder 320 decodes the TCM coded data because the equalized data is the TCM coded data which is encoded to the TCM code using the TCM encoding scheme at the data transmitting apparatus. That is, the LDPC decoder 320 decodes the TCM coded data based on a LDPC decoding scheme using an iterative decoding algorithm. The TCM coded data is a linear code. Here, the LDPC decoder 320 eliminates noise from the LDPC decoded data, which is generated when the broadcasting data was transmitted through a wireless channel.

In more detail, the LDPC decoder 320 calculates a Parity check Matrix of a TCM code from the TCM coded data based on Trellis. Then, the LDPC decoder 320 converts the Parity Check Matrix to the LDPC Matrix. The LDPC decoder 320 converts the calculated Parity Check Matrix of the TCM code in order that the LDPC matrix has less short cycles in a Tanner graph. Preferably, the calculated Parity Check Matrix is converted in order that the LDPC matrix has minimum short cycles in the Tanner graph. Since the data transmitting apparatus encodes the broadcasting data to the TCM code and the RS code, the LDPC decoder 320 calculates a Parity Check Matrix of the TCM code from the TCM coded data. Also, the LDPC decoder 320 converts the calculated parity check matrix of the TCM code to the LDPC matrix. The LDPC decoder 320 decodes the TCM coded data using a LDPC decoding scheme using an iterative decoding algorithm based on the converted LDPC matrix. For example, a sum-product algorithm (SPA) or a minimum sum algorithm may be used as the iterative decoding algorithm. Since the converted LDPC matrix has small short cycles in a Tanner graph, the decoding performance of the LDPC decoder 320 becomes close to Shannon's channel capacity limit. Therefore, the decoding performance of the data receiving apparatus becomes maximized.

The deinterleaver 325 deinterleaves the LDPC decoded data. The RS decoder 330 decodes the deinterleaved data based on a RS decoding scheme corresponding to a RS encoding scheme of the data transmitting apparatus. That is, the RS decoder 330 decodes the RS coded data which was coded to a RS code at the data transmitting apparatus. Here, the RS code is a linear code. Here, the burst error of the RS decoded data is corrected by the RS decoder 330. That is, the RS decoder 330 removes noise from the RS decoded data. The noise is generated when the broadcasting data is transmitted through a wireless channel. The data derandomizer 335 restores a MPEG-2 TS broadcasting data from the received broadcasting data by derandomizing the RS decoded data.

As described above, when the data receiving apparatus in accordance with an embodiment of the present invention receives the broadcasting data coded to the RS code and the TCM code which are a linear code, the data receiving apparatus decodes the RS coded and TCM coded broadcasting data using an iterative decoding algorithm. That is, when the data receiving apparatus in accordance with an embodiment of the present invention receives the broadcasting data coded to the TCM code based on a linear code, particularly Trellis, the data receiving apparatus calculates a Parity Check Matrix of a TCM code from the TCM coded broadcasting data and performs the LDPC decoding by converting the calculated Parity Check Matrix of the TCM code to the LDPC matrix.

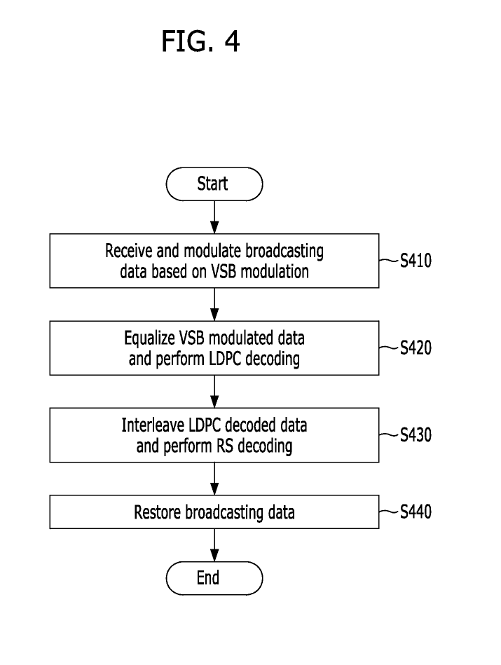

Since the data receiving apparatus in accordance with an embodiment of the present invention performs the LDPC decoding as described above, the decoding performance of the broadcasting data coded to the RS code and the TCM code such as the decoding performance of the TCM code becomes close to Shannon's channel capacity limit. Accordingly, the decoding error of the received broadcasting data is minimized. That is, the data receiving apparatus in accordance with an embodiment of the present invention decodes broadcasting data received through an antenna using an iterative decoding algorithm. In other word, the data receiving apparatus in accordance with an embodiment of the present invention stably provides a high quality digital broadcasting without the deterioration of the decoding performance by performing the LDPC decoding. Hereinafter, the operations of the data receiving apparatus in accordance with an embodiment of the present invention, which receives and decodes broadcasting data coded to a RS code and a TCM code, will be described in detail with reference to FIG. 4.

FIG. 4 is a flowchart showing an operation of a data receiving apparatus in accordance with an embodiment of the present invention.

Referring to FIG. 4, at step S410, the data receiving apparatus in accordance with an embodiment of the present invention receives broadcasting data through an antenna from a data transmitting apparatus, down-converts the received broadcasting data from a RF band broadcasting data to a baseband broadcasting data and demodulates the down-converted broadcasting data using a VSB demodulation scheme corresponding to a VSB modulation scheme of the data transmitting apparatus.

At step S420, the data receiving apparatus in accordance with an embodiment of the present invention equalizes the VSB demodulated broadcasting data and decodes the equalized broadcasting data using a LDPC decoding scheme. For example, an iterative decoding algorithm is used. As described above, the broadcasting data received through the antenna is data coded at the data transmitting apparatus to a RS code and a TCM code. Here, the RS code and the TCM code are a linear code. In the LDPC decoding, the parity check matrix of the TCM code is calculated from the received broadcasting data based on Trellis. The calculated parity check matrix of the TCM code is converted to a LDPC matrix for LDPC decoding. The broadcasting data received through the antenna is restored based on the LDPC matrix.

The calculated Parity Check Matrix of the TCM code is converted to the LDPC matrix having the comparatively small number of short cycles in a Tanner graph. Since the data transmitting apparatus encodes the broadcasting data to the TCM code and the RS code, the Parity Check Matrix of the TCM code can be calculated from the broadcasting data received through the antenna. Also, the calculated Parity Check Matrix of the TCM code is converted to the LDPC matrix. Based on the LDPC matrix, the received broadcasting data is restored using the iterative decoding algorithm such as a sum-product algorithm or a min-sum algorithm. Since the LDPC matrix has the comparatively small number of short cycles in a tanner graph, preferably the minimum number of short cycles in a tanner graph, the decoding performance of the broadcasting data received through the antenna becomes close to Shannon's channel capacity limit. Therefore, the decoding performance becomes maximized. Here, the LDPC decoding also remove noise from the LDPC decoded data. The noise may be generated when the broadcasting data was transmitted through a wireless channel.

At step S430, the data receiving apparatus in accordance with an embodiment of the present invention interleaves the LDPC decoded broadcasting data to maximize the decoding performance. Accordingly, the decoding error of the received broadcasting data is minimized. The data receiving apparatus in accordance with an embodiment of the present invention decodes the deinterleaved data using a RS decoding scheme. Here, the RS decoding may correct burst error of the RS decoded data and remove noise from the RS decoded data. The noise may be generated when the broadcasting data was transmitted through a wireless channel.

At step S440, the data receiving apparatus in accordance with an embodiment of the present invention restores the broadcasting data received through the antenna by derandomizing the RS-decoded data and outputs the MPEG-2 TS broadcasting data.

As described above, the data receiving apparatus in accordance with an embodiment of the present invention decodes broadcasting data transmitted from the data transmitting apparatus through an antenna using an iterative decoding algorithm. That is, the data receiving apparatus in accordance with an embodiment of the present invention decodes the received broadcasting data using the LDPC decoding scheme. The decoding performance of the received broadcasting data becomes close to Shannon's Channel capacity limit. Particularly, the decoding performance of the TCM coded broadcasting data becomes close to Shannon's channel capacity limit. Thus, the decoding error of the received broadcasting data becomes minimized. Therefore, the data receiving apparatus stably provides a high quality digital broadcasting without the deterioration of the decoding performance of the broadcasting data received through the antenna.

The present application contains a subject matter related to Korean Patent Application Nos. 10-2009-0109603 and 10-2010-0046294 filed in the Korean Intellectual Property Office on Nov. 13, 2009 and May 19, 2010, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. An apparatus for receiving data in a communication system, comprising:
a demodulator configured to demodulate data received through an antenna using a Vestigial SideBand (VSB) demodulation scheme;
an equalizer configured to equalize the demodulated data;
a first decoder configured to decode the equalized data using a Low-Density Parity Check (LDPC) decoding scheme;
a deinterleaver configured to deinterleave the LDPC decoded data;
a second decoder configured to decode the deinterlevaed data using a Reed-Solomon (RS) decoding scheme; and
a derandomizer configured to restore the data received through the antenna by derandomizing the RS-decoded data.

2. The apparatus of claim 1, wherein the first decoder calculates a Parity Check Matrix of a Trellis Coded Modulation (TCM) code from the equalized data.

3. The apparatus of claim 2, wherein the first decoder converts the calculated Parity Check Matrix to a Low-Density Parity Check (LDPC) matrix and decodes the equalized data based on the LDPC matrix.

4. The apparatus of claim 3, wherein the first decoder decodes the equalized data using an iterative decoding algorithm based on the LDPC matrix.

5. The apparatus of claim 3, wherein the first decoder decodes the equalized data using a sum-product algorithm or a min-sum algorithm based on the LDPC matrix.

6. The apparatus of claim 3, wherein the first decoder converts the calculated Parity Check Matrix in order that the LDPC matrix has minimum short cycles in a Tanner graph.

7. The apparatus of claim 1, further comprising a tuner configured to down-convert the data received through the antenna from a Radio Frequency (RF) band to an Intermediate Frequency (IF) band or a base band and to output the down-converted data to the modulator.

8. The apparatus of claim 1, wherein the equalizer removes a multipath signal from the data received through the antenna; and
the first and second decoders eliminate noise from the data received through the antenna.

9. An apparatus for receiving data in a communication system, comprising a decoder configured to decode data received through an antenna using an iterative decoding algorithm,
wherein the decoder decodes a Trellis Coded Modulation (TCM) code of the data received through the antenna based on a Low-Density Parity Check (LDPC) decoding scheme using an iterative decoding algorithm.

10. The apparatus of claim 9, wherein the decoder includes:
a first decoder configured to decode a Trellis Coded Modulation (TCM) code of the data received through the antenna; and
a second decoder configured to decode a Reed-Solomon (RS) code of the data received through the antenna.

11. The apparatus of claim 9, wherein the decoder calculates a Parity Check Matrix of the TMC code from the data received through the antenna.

12. The apparatus of claim 11, wherein the decoder converts the calculated Parity Check Matrix to a Low-Density Parity Check (LDPC) matrix and decodes the data received through the antenna using the iterative decoding algorithm based on the LDPC matrix.

13. The apparatus of claim 12, wherein the decoder decodes the data received through the antenna using a sum-product algorithm or a min-sum algorithm based on the LDPC matrix.

14. The apparatus of claim 12, wherein the decoder decodes the calculated Parity Check Matrix in order that the LDPC matrix has minimum short cycles in a Tanner graph.

15. A method for receiving data in a communication system, comprising:
calculating a Parity Check Matrix of a Trellis Coded Modulation (TCM) code from data received through an antenna;
converting the calculated Parity Check Matrix to a Low-Density Parity Check (LDPC) matrix; and
decoding the data received through the antenna based on the LDPC matrix and restoring the data received through the antenna.

16. The method of claim 15, wherein in said decoding the data received through the antenna based on the LDPC matrix,
the data received through the antenna is decoded using an iterative decoding algorithm.

17. The method of claim 15, wherein in said decoding the data received through the antenna based on the LDPC matrix,
the data received through the antenna is decoded using a sum-product algorithm or a min-sum algorithm.

18. The method of claim 15, wherein in said decoding the data received through the antenna based on the LDPC matrix,
a Trellis Coded Modulation (TCM) code of the data received through the antenna is decoded, and a Reed-Solomon (RS) code of the data received through the antenna is decoded.

19. The method of claim 15, wherein said converting the calculated Parity Check Matrix to a Low-Density Parity Check (LDPC) matrix,
the calculated Parity Check Matrix is converted in order that the LDPC matrix has minimum number of short cycles in a Tanner graph.

20. The method of claim 15, wherein said decoding the data received through the antenna based on the LDPC matrix and restoring the data received through the antenna,
the data received through the antenna is restored by derandomizing the decoded data.
